(19) United States
(12) Patent Application Publication
(10) Pub. No.: US 2024/0428080 A1
(43) Pub. Date: Dec. 26, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Yusuke NATSUI, Yokohama Kanagawa (JP)

(73) Assignee: KABUSHIKI KAISHA TOSHIBA, Tokyo (JP)

(21) Appl. No.: 18/588,990

(22) Filed: Feb. 27, 2024

(30) Foreign Application Priority Data
Jun. 20, 2023 (JP) 2023-100781

(51) Int. Cl. G06N 3/096

(52) U.S. Cl. CPC G06N 3/096

(57) ABSTRACT

According to one embodiment, an information processing device includes a target model learning unit, a change unit, a selection unit, and a student model learning unit. The target model learning unit learns a target model to be subjected to size reduction. The change unit changes the target model into a student model with a size smaller than a size of the target model. The selection unit selects, as a teacher model, one of a plurality of models including the target model and one or more intermediate models with a size smaller than the size of the target model in accordance with a comparison result between the size of the target model and the size of the student model. The student model learning unit learns the student model by distillation using the selected teacher model.

### CROSS-REFERENCE TO RELATED APPLICATIONS

This application is based upon and claims the benefit of priority from Japanese Patent Application No. 2023-100781, filed on Jun. 20, 2023; the entire contents of which are incorporated herein by reference.

### FIELD

Embodiments described herein relate generally to an information processing device, an information processing method, and a computer program product.

### BACKGROUND

In neural networks such as a deep neural network (DNN), the size of the model may be reduced, for example, for reduction of the amount of computation and storage capacity of the model in consideration of inference of the model at high speed in an environment with limited computing resources such as edge terminals. In one of the known techniques for improving the accuracy of the model after the size reduction, a student model, which is the model after the size reduction, is learned by distillation (also called knowledge distillation) using the model before the size reduction as a teacher model.

### BRIEF DESCRIPTION OF THE DRAWINGS

FIG. 1 is a block diagram of an information processing device according to an embodiment;

FIG. 2 is a diagram illustrating an example of changing a target model into a student model;

FIG. 3 is a diagram illustrating an example of generating an intermediate model and a student model from the target model;

FIG. 4 is a block diagram of a change unit;

FIG. 5 is a diagram illustrating an example of the student model;

FIG. 6 is a block diagram of a selection unit;

FIG. 7 is a diagram for describing the summary of a selection process for an initial parameter;

FIG. 8 is a diagram illustrating an example of a process for obtaining combinations;

FIG. 9 is a diagram schematically illustrating a selection of the combinations using evaluation values;

FIG. 10 is a diagram schematically illustrating a selection of the combinations using the evaluation values;

FIG. 11 is a diagram schematically illustrating a selection of the combinations using the evaluation values;

FIG. 12 is a flowchart of a learning process in the embodiment;

FIG. 13 is a block diagram of an information processing device according to a modification; and

FIG. 14 is a hardware structure diagram of the information processing device according to the embodiment.

### DETAILED DESCRIPTION

According to an embodiment, an information processing device includes one or more hardware processors configured to function as a target model learning unit, a change unit, a selection unit, and a student model learning unit. The target model learning unit learns a target model to be subjected to size reduction. The change unit changes the target model into a student model with a size smaller than a size of the target model. The selection unit selects, as a teacher model, one of a plurality of models including the target model and one or more intermediate models with a size smaller than the size of the target model in accordance with a comparison result between the size of the target model and the size of the student model. The student model learning unit learns the student model by distillation using the selected teacher model. Exemplary embodiments of an information processing device according to the present disclosure will be explained below in detail with reference to the accompanying drawings.

In a process of reducing the size of a model, the ratio of the size of a student model to the size of a teacher model (the size reduction ratio) can vary. For example, if the reduction ratio is large, the accuracy of learning by distillation may decrease due to the large difference between the student model and the teacher model.

In the embodiment below, the teacher model is selected according to the size of the student model (the model after size reduction) to be learned by distillation. An initial value of the parameter (initial parameter) at the learning of the student model is selected from the parameters of the model to be subjected to the size reduction (hereinafter referred to as a target model). Thus, the learning by distillation of the models with the reduced size can be performed with higher accuracy.

In addition, in the conventional art, if pre-learning is required for the target model, pre-learning is also required for the student model after the size reduction. In the embodiment, selecting the initial parameter suitably can eliminate the need for pre-learning of the student model. This will reduce the cost of learning.

In the embodiment, one of a plurality of models, including the target model and one or more intermediate models, is selected as the teacher model in accordance with the size ratio between the student model and the target model. The intermediate model is smaller in size than the target model. The initial parameter of the student model is selected from the initial parameters of the target model, based on the evaluation value.

In an example described below, the model (target model, intermediate model, and student model) is a neural network model (hereinafter also referred to as a neural network simply). The model is not limited to this and can be a model with any other structure. A neural network includes a plurality of layers each including a plurality of elements.

For example, if the neural network is a convolutional neural network (CNN), the elements may be a plurality of channels included in the convolutional layer. The element is not limited to this example and may be any other element. In another example, the element may be a node included in each layer of the neural network. In an example described below, the element is a channel.

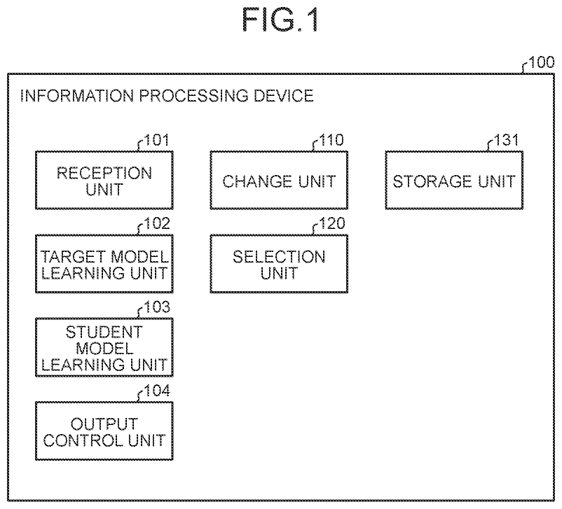

FIG. 1 is a block diagram illustrating an example of a structure of an information processing device 100. As illustrated in FIG. 1, the information processing device 100 includes a reception unit 101, a target model learning unit 102, a student model learning unit 103, an output control unit 104, a change unit 110, a selection unit 120, and a storage unit 131.

The reception unit 101 receives the input of various types of information used in the information processing device 100. For example, the reception unit 101 receives information representing the target model (for example, parameters such as weight and bias), a plurality of pieces of learning data (learning datasets) used for the learning of the model, and the like.

The target model learning unit 102 learns the target model to be subjected to the size reduction. For example, the target model learning unit 102 learns the target model using the learning dataset for learning.

The change unit 110 changes the target model into a student model that is smaller in size than the target model. The student model is the model that is learned by distillation using the teacher model. For example, the change unit 110 changes the target model into the student model by deleting a part of the channels included in each of the layers in the target model. Changing the target model into the student model can be interpreted as being equivalent to generating the student model from the target model.

Any method may be employed for the change unit 110 to change the target model into the student model; for example, the following methods (M1) to (M3) below can be employed. Note that each of the following methods can generate one or more intermediate models along with the student model.

(M1) The student model is generated by uniformly reducing the number of channels in each of the layers included in the target model. For example, the number of channels in each layer of the target model is decreased by a designated ratio (hereinafter also referred to as scale). Hereinafter, changing (increasing or decreasing) the number of channels on a designated scale may be referred to as scaling.

The channel to be decreased by scaling may be selected in any way. For example, a random selection method, a method that continuously selects channels, whose number corresponds to the scale, from a specific position (beginning, middle, end, etc.), or other method can be employed.

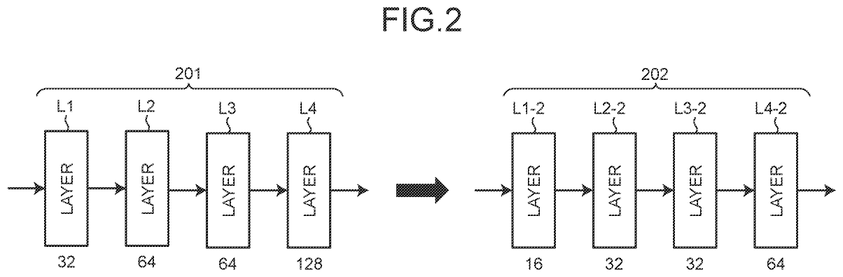

FIG. 2 is a diagram illustrating an example of changing a target model 201 into a student model 202 according to (M1). The target model 201 includes four layers L1 to L4. The student model 202 includes four layers L1-2 to L4-2. The numeral listed under each layer indicates the number of channels included in the corresponding layer. In the example in FIG. 2, the designated scale is 0.5. As illustrated in FIG. 2, the number of channels in each of the four layers included in the target model 201 is reduced according to a scale of 0.5 to generate the student model 202.

The change unit 110 may change the target model into a plurality of models according to a plurality of scales, and one of the changed models may be used as the student model and the rest may be used as the intermediate models. For example, the change unit 110 may scale the target model to the intermediate model using a scale of 0.75 and scale the target model to the student model using a scale of 0.5. Thus, the intermediate model may be larger in size than the student model. The intermediate model may have the same size as the student model or be smaller in size than the student model.

(M2) The target model is pruned to generate the student model. Pruning, for example, is a process of finding an operation that can be reduced among a plurality of operations realized by the target model and generating a model with such an operation reduced. Any pruning method can be used; for example, the methods according to the following may be employed: Hao Li, et al., “PRUNING FILTERS FOR EFFICIENT CONVNETS”, arXiv:1608.08710v3 10 Mar. 2017; and A. Yaguchi, et al., “Adam Induces Implicit Weight Sparsity in Rectifier Neural Networks”, Proc. of the 17th IEEE International Conference on Machine Learning and Applications (ICMLA) 2018.

The change unit 110 may generate models in a plurality of sizes by changing pruning intensities, and one of the generated models may be used as the student model and the rest may be used as the intermediate models. For example, in the method of calculating the importance for each channel as in the method according to Hao Li, et al., “PRUNING FILTERS FOR EFFICIENT CONVNETS”, arXiv:1608.08710v3 10 Mar. 2017, the intensity can be manipulated by changing the threshold for determining the channel to be reduced (the importance threshold). In the method using compacting to learn sparse models with many zeros in the weights, such as the method according to A. Yaguchi, et al., “Adam Induces Implicit Weight Sparsity in Rectifier Neural Networks”, Proc. of the 17th IEEE International Conference on Machine Learning and Applications (ICMLA) 2018, the intensity can be manipulated by changing the parameter (for example, weight decay) at the learning.

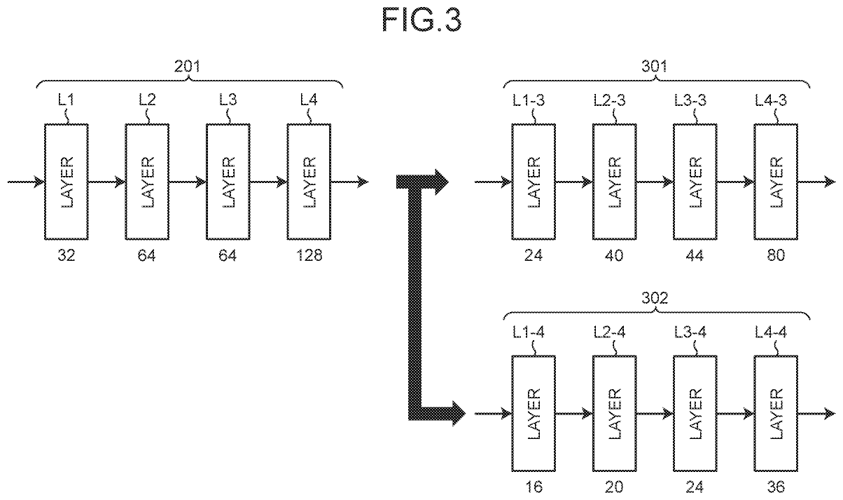

FIG. 3 is a diagram illustrating an example of generating an intermediate model 301 and a student model 302 from the target model 201 according to (M2). The intermediate model 301 includes four layers L1-3 to L4-3. The student model 302 includes four layers L1-4 to L4-4. The intermediate model 301 corresponds to a model generated with smaller intensity. The student model 302 corresponds to a model generated with greater intensity than the intermediate model 301. Because the intensity is relatively small, the degree of degradation of the accuracy of the intermediate model 301 is relatively smaller than that of the student model 302.

(M3) One or more intermediate models are generated by pruning on the target model and by scaling on one of the generated intermediate models, the student model is generated.

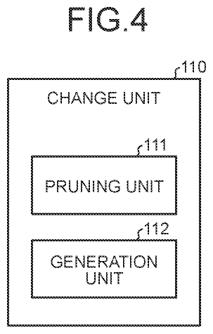

FIG. 4 is a block diagram illustrating an example of a structure of the change unit 110 when (M3) is employed. As illustrated in FIG. 2, the change unit 110 includes a pruning unit 111 and a generation unit 112.

The pruning unit 111 generates one or more intermediate models by pruning on the target model. The generation unit 112 generates the student model by scaling the size of each of the layers included in one of the intermediate models by a designated scale.

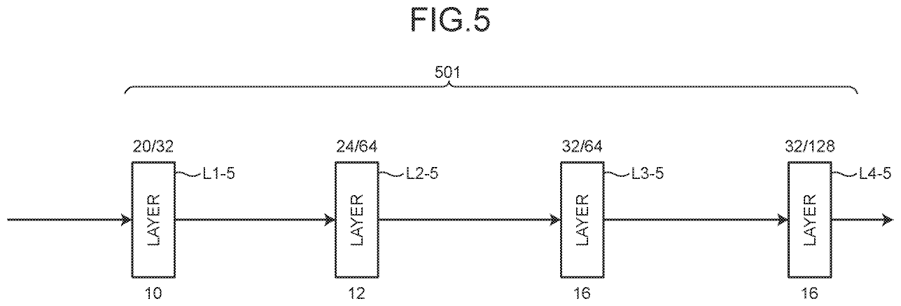

FIG. 5 is a diagram illustrating an example of a student model 501 generated according to (M3). The student model 501 includes four layers L1-5 to L4-5. The numerals listed over each layer indicate the number of channels before and after pruning included in the corresponding layer. The numeral on the right of the symbol “/” represents the number of channels before pruning, and the number on the left of the symbol “/” represents the number of channels after pruning. The numeral listed under each layer indicates the number of channels after scaling included in the corresponding layer. In this example, the scale is 0.5.

Referring back to FIG. 1, the selection unit 120 selects the teacher model to be used in the learning by distillation of the student model. The selection unit 120 also selects the initial value of the parameter (initial parameter) when the student model is learned. Examples of the parameter include weight and bias.

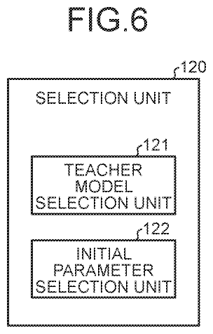

FIG. 6 is a block diagram illustrating a detailed example of function structures of the selection unit 120. As illustrated in FIG. 6, the selection unit 120 includes a teacher model selection unit 121 and an initial parameter selection unit 122.

The teacher model selection unit 121, for example, selects one of the models, including the target model and one or more intermediate models, as the teacher model according to the comparison result between the size of the target model and the size of the student model. For example, the teacher model selection unit 121 calculates the ratio of the size of the student model to the size of the target model (=size of student model/size of target model). The size may be calculated in any way and may be calculated by, for example, the size of the parameter of the model (data size) and the number of floating-point operations (FLOPs) at the inference using the model.

The teacher model selection unit 121 compares the calculated ratio with the threshold, and selects the target model as the teacher model if the ratio is greater than the threshold, and selects the intermediate model as the teacher model if the ratio is less than or equal to the threshold. If two or more intermediate models are generated, the teacher model selection unit 121 may use a plurality of thresholds to select the intermediate model with the size corresponding to the ratio. The threshold is determined in advance, for example, depending on the type of target model.

The initial parameter selection unit 122 selects the initial parameters (initial values) for the layers included in the student model from the parameters of the layers included in the target model.

The initial parameters are, for example, the initial values of the parameters to be set for one or more channels to be included in each layer at the start of learning. For example, the initial parameter selection unit 122 selects the initial parameters for one or more channels to be included in each of the layers in the student model, from the parameters of the channels included in the layers in the target model.

The parameters of the channels included in the layers in the target model may be the parameters before learning of the target model (initial values of the parameters) or the parameters after learning of the target model.

The following method can be employed to select the initial parameters, for example. First, for each of the layers (intermediate model layers) included in the intermediate model, the initial parameter selection unit 122 obtains a plurality of combinations (a plurality of element groups) including a part of the channels selected from the channels included in the corresponding layer. The initial parameter selection unit 122 selects the channels included in the combination, among the combinations, whose evaluation value is greater than those of the other combinations. The initial parameter selection unit 122 selects, for the selected channel, the parameter set in the corresponding channel of the corresponding layer of the target model as the initial parameter.

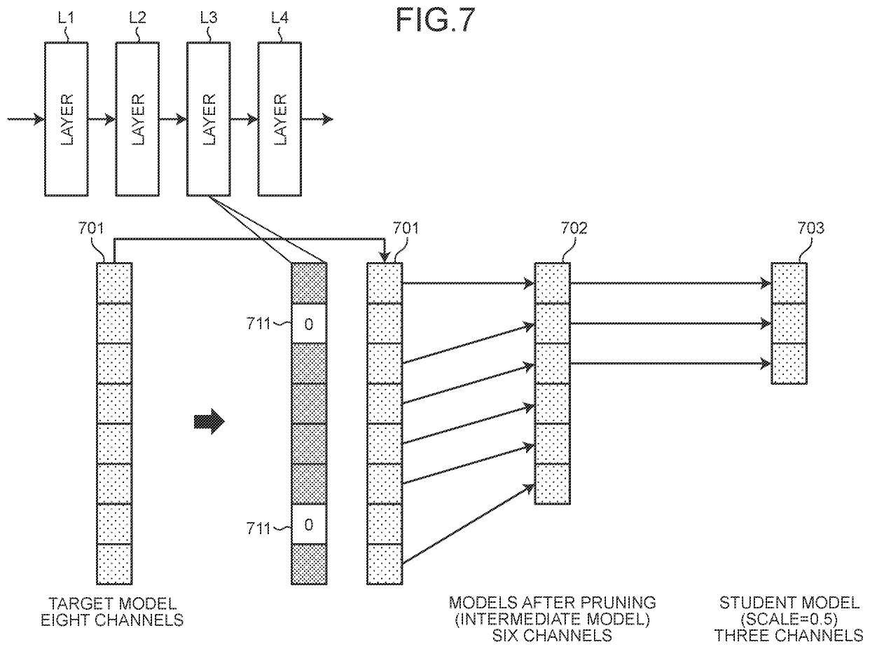

FIG. 7 is a diagram for describing the summary of a selection process for the initial parameter. FIG. 7 illustrates an example of selecting the initial parameter for the layer L3 among the four layers L1 to L4 included in the student model. The similar process is performed for the other layers L1, L2, and L4.

In the example illustrated in FIG. 7, the number of channels in the layer L3 of a target model 701 is eight, and, by deleting the channels 711 that have become deletion targets by pruning, an intermediate model 702 in which the layer L3 has six channels is generated. The initial parameter selection unit 122 obtains a plurality of combinations including three channels from the six channels included in the layer L3 of the intermediate model 702.

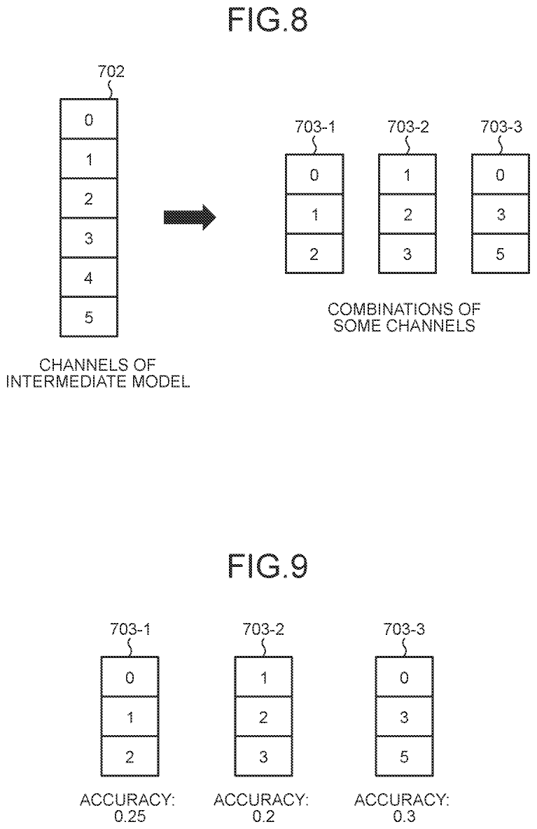

FIG. 8 is a diagram illustrating an example of obtaining three combinations. The numeral in the intermediate model 702 is the information that identifies the channel. The initial parameter selection unit 122 selects three mutually different channels from the six channels of the intermediate model 702 to obtain three combinations 703-1, 703-2, and 703-3. The number of combinations is not limited to three, and may alternatively be two, or four or more.

Referring back to FIG. 7, the initial parameter selection unit 122 selects the three channels included in the combination with the large evaluation value among the three combinations. The model including the three selected channels corresponds to a student model 703. The initial parameter selection unit 122 sets the initial parameter of each channel included in the layer L3 of the student model 703 by selecting from the parameters of the corresponding channels in the layer L3 of the target model 701. The parameter to be selected at this time may be the parameter before the learning of the target model 701 (initial value of parameter) or the parameter after the learning of the target model 701. The initial parameter selection unit 122 may set the initial parameter by selecting from the parameters of the corresponding channels of the layer L3 of the intermediate model 702 after pruning.

The evaluation value is a value to evaluate whether the channels included in each combination are suitable, and may be, for example, any of indicators shown in (E1) through (E3) below. In the following description, the student model in which the parameter of the channel of the target model corresponding to the channel included in the combination is set as the initial value is referred to as a candidate model. The evaluation value is calculated for each candidate model.
(E1) A value representing the accuracy of the inference using the candidate model (accuracy rate of inference or the like)
(E2) A value that becomes larger as the difference is smaller between the statistic (i.e., amount of statistics) of the output of the layer included in the candidate model and the statistic of the output of the corresponding layer included in the intermediate model when the inference using the candidate model is performed on a plurality of pieces of data
(E3) A value that becomes larger as the difference is smaller between the statistic of the gradient calculated for the layer included in the candidate model and the statistic of the gradient calculated for the corresponding layer included in the intermediate model when a backward process using the candidate model is performed for the pieces of data

The statistic used in (E2) and (E3) can be any value; for example, an average value, variance, a maximum value, or a minimum value may be used. A combination of two or more statistics may be used as the evaluation value. For example, the absolute sum or the sum of squares of the differences of a plurality of statistics may be used as the evaluation value. The backward process performed in (E3) is a process of calculating the gradient (derivative) of each layer with respect to the model error in a direction from the output layer to the input layer of the model.

FIG. 9 to FIG. 11 are diagrams schematically illustrating the selection of the combinations (student models) using the evaluation values of (E1) to (E3), respectively.

FIG. 9 illustrates examples of the evaluation values (accuracy) of the combinations 703-1, 703-2, and 703-3. For example, the initial parameter selection unit 122 learns the candidate model corresponding to each combination using the learning data. The number of times of repeating the learning here may be determined so that the accuracy of the candidate models after the learning can be compared. The initial parameter selection unit 122 performs the inference on each of the candidate models after the learning and calculates the accuracy of the inference (accuracy rate or the like) as the evaluation value. In the example in FIG. 9, the initial parameter selection unit 122 selects the combination 703-3 corresponding to the candidate model with the largest evaluation value.

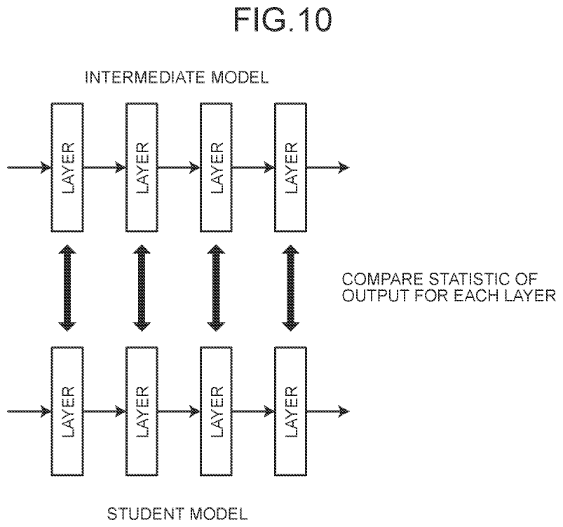

In FIG. 10, the initial parameter selection unit 122 performs the inference using pieces of data (partial pieces of datasets). For each layer, the initial parameter selection unit 122 compares the statistic of the output of the layer when the inference is performed on the pieces of data with the statistic of the output of the corresponding layer of the intermediate model. The initial parameter selection unit 122 selects the student models (candidate models) with the closest statistics (smallest difference).

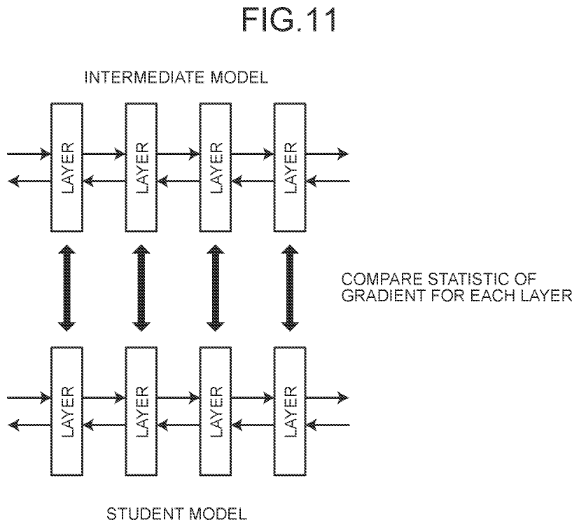

In FIG. 11, the initial parameter selection unit 122 performs the inference and the backward process with pieces of data (partial pieces of datasets). For each layer, the initial parameter selection unit 122 compares the statistic of the gradient calculated by the backward process for the pieces of data with the statistic of the gradient calculated for the corresponding layer of the intermediate model. The initial parameter selection unit 122 selects the student models (candidate models) with the closest statistics (smallest difference).

The initial parameter selection unit 122 selects the initial parameter of each layer of the student model corresponding to the selected combination as illustrated in FIG. 9 to FIG. 11 from the parameters of the corresponding layers included in the target model.

Referring back to FIG. 1, the student model learning unit 103 learns the student model by distillation using the teacher model selected by the teacher model selection unit 121. At this time, the student model learning unit 103 learns the student model using the initial parameter selected by the initial parameter selection unit 122.

The output control unit 104 controls the output of various types of information used by the information processing device 100. For example, the output control unit 104 outputs information (for example, parameter) representing the learned student model to an external device or other device that performs the inference using the student model.

Each of the above units (reception unit 101, target model learning unit 102, student model learning unit 103, output control unit 104, change unit 110, and selection unit 120) is realized by, for example, one or more processors. For example, each of the above units may be realized by having a processor such as a central processing unit (CPU) and a graphics processing unit (GPU) execute a computer program, i.e., by software. Each of the above units may be realized by a processor such as a dedicated integrated circuit (IC), i.e., hardware. Each of the above units may be realized using software and hardware in combination. When the processors are used, each processor may realize one of the units or two or more of the units.

The storage unit 131 stores therein various kinds of information used in the information processing device 100. For example, the storage unit 131 stores therein information received by the reception unit 101 (information representing the target model, learning data, and the like), information representing the learned student model, and the like.

The storage unit 131 can be formed by any commonly used storage medium such as a flash memory, a memory card, a random access memory (RAN), a hard disk drive (HDD), or an optical disk.

The information processing device 100 may be formed by a single device physically or a plurality of devices physically. For example, the information processing device 100 may be constructed on a cloud environment. The units inside the information processing device 100 may be distributed among a plurality of devices.

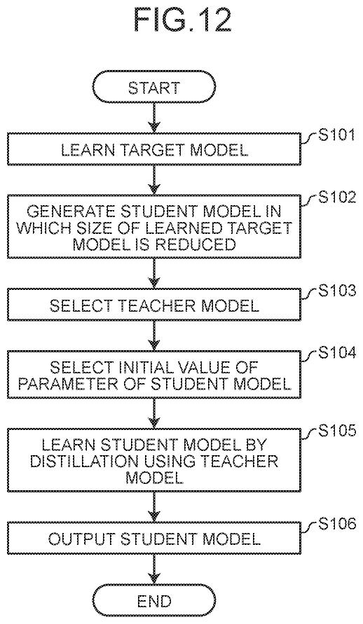

Next, the learning process of the information processing device 100 according to this embodiment will be described. The learning process is a process of learning the student model, which is obtained by reducing the size of the target model, by distillation using the teacher model. FIG. 12 is a flowchart expressing one example of the learning process in this embodiment.

The target model learning unit 102 learns the target model using the learning dataset (step S101). The change unit 110 changes (reduces) the size of the learned target model to generate the student model (step S102).

The selection unit 120 (teacher model selection unit 121) selects one of the target model and the intermediate model as the teacher model to be used for the learning of the student model (step S103). For example, the teacher model selection unit 121 calculates the ratio of the student model size to the target model size and selects the target model as the teacher model if the ratio is greater than a threshold. If the ratio is less than or equal to the threshold, the teacher model selection unit 121 selects the intermediate model as the teacher model.

The selection unit 120 (initial parameter selection unit 122) selects the initial value of the parameter (initial parameter) used to learn the student model (step S104).

The student model learning unit 103 learns the student model by distillation using the selected teacher model with the use of the selected initial parameter (step S105).

The output control unit 104 outputs information (parameter or the like) representing the learned student model (step S106) and terminates the learning process.

In the description made above, the selection unit 120 performed both the selection of the teacher model (teacher model selection unit 121) and the selection of the initial parameter (initial parameter selection unit 122). The information processing device 100 may be configured to perform only one of these.

If a function is provided to select the teacher model in consideration of the size of the student model, for example, if the difference between the student model and the target model is large, the intermediate model with the smaller difference can be selected as the teacher model. This can suppress the decrease in accuracy of learning caused by the difference between the student model and the teacher model.

If a function is provided to select the initial parameter of the student model from the parameters of the target model, for example, the initial parameter can be set suitably compared to a method of initializing the initial parameter with random numbers, thereby heightening the accuracy after learning the student model.

Thus, the information processing device according to the embodiment can perform the learning of the model with the reduced size by distillation with higher accuracy.

### Modification

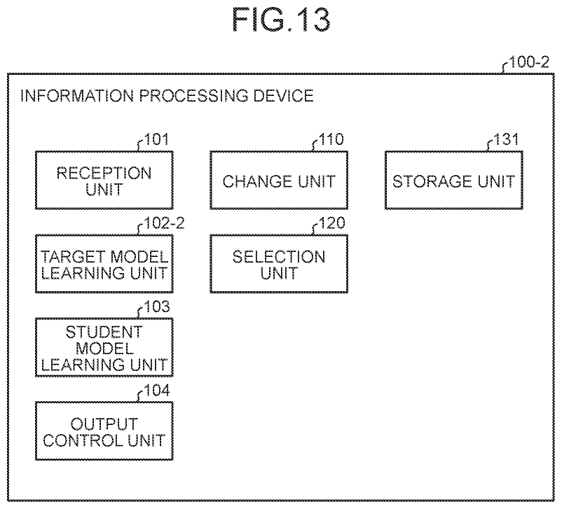

The information processing device may further have a function of pre-learning the target model. This modification will describe an example with a pre-learning function. FIG. 13 is a block diagram illustrating an example of a structure of an information processing device 100-2 according to the modification. As illustrated in FIG. 13, the information processing device 100-2 includes the reception unit 101, a target model learning unit 102-2, the student model learning unit 103, the output control unit 104, the change unit 110, the selection unit 120, and the storage unit 131.

In the modification, the function of the target model learning unit 102-2 is different from that in the above embodiment. The other structures and functions are similar to those in the block diagram of the information processing device 100 according to the embodiment in FIG. 1; therefore, the same symbols are given and the description is omitted here.

The target model learning unit 102-2 is different from the target model learning unit 102 in the above embodiment in that the target model learning unit 102-2 further performs the pre-learning of the target model. For example, the target model learning unit 102-2 pre-learns the target model using a learning dataset DS_A for pre-learning (first dataset), and learns the pre-learned target model using a learning dataset DS_B (second dataset), which is different from the learning dataset DS_A.

The learning dataset DS_A, for example, is a large-scaled dataset prepared in advance, which is capable of learning generic features and being easily transferred to other tasks. The learning dataset DS_B, for example, is a dataset for learning so as to be the model more suitable for a particular task.

If the pre-learning is performed, the initial parameter selection unit 122 may select the parameter of the target model after the pre-learning as the initial parameter of the student model. This eliminates the need for pre-learning of the student model, even when, for example, a target model that requires pre-learning is used. This will reduce the cost of learning.

The information processing devices according to the above embodiment and the modification can be applied to learning of models used in various systems. The system may be any system that has a function using models, and may be a system that uses models on an edge terminal with small storage capacity as follows, for example.
(1) A detection system in which a server device detects objects such as people (flow of people) using information detected by an edge terminal (for example, information detected from images obtained by an imaging device (camera))
(2) A control system in which a control device controls an apparatus to be controlled (lighting equipment, elevators, etc.) using information detected by an edge terminal (for example, information detected from sensor data obtained from a sensor)

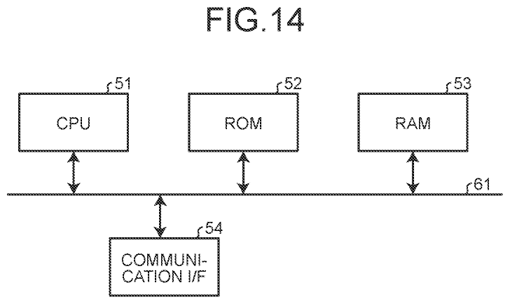

Next, a hardware structure of the information processing device according to the embodiment is described with reference to FIG. 14. FIG. 14 is an explanatory diagram illustrating an example of a hardware structure of the information processing device according to the embodiment.

The information processing device according to the embodiment includes a control device such as a CPU 51, a storage device such as a read only memory (ROM) 52 or a RAM 53, a communication I/F 54 that connects to a network for communication, and a bus 61 that connects between the units.

The computer program to be executed in the information processing device according to the embodiment may be provided by being incorporated in advance in the ROM 52 or the like.

The computer programs to be executed in the information processing device according to the embodiment may be stored in a computer-readable storage medium such as a compact disk read only memory (CD-ROM), a flexible disk (FD), a compact disk recordable (CD-R), or a digital versatile disk (DVD) as files in an installable or executable format and provided as a computer program product.

This computer program to be executed in the information processing device according to the embodiment may be provided by being stored on a computer connected to a network such as the Internet and downloaded through the network. The computer program to be executed in the information processing device according to the embodiment may alternatively be provided or distributed through a network such as the Internet.

The computer program to be executed in the information processing device according to the embodiment can cause a computer to function as each unit of the information processing device described above. This computer can cause the CPU 51 to read out and execute the computer program from a computer-readable storage medium on its main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
a target model learning unit that learns a target model to be subjected to size reduction;
a change unit that changes the target model into a student model with a size smaller than a size of the target model;
a selection unit that selects, as a teacher model, one of a plurality of models including the target model and one or more intermediate models with a size smaller than the size of the target model in accordance with a comparison result between the size of the target model and the size of the student model; and
a student model learning unit that learns the student model by distillation using the selected teacher model.

2. The information processing device according to claim 1, wherein
the selection unit further selects an initial value of a parameter of the student model from parameters of the target model, and
the student model learning unit learns the student model using the selected initial value.

3. The information processing device according to claim 2, wherein
the target model is a neural network model including a plurality of layers each including a plurality of elements,
the student model is a neural network model including a plurality of layers each including a plurality of elements,
the change unit changes the target model into the student model by deleting a part of the elements included in the target model, and
the selection unit selects the initial value of the parameter of an element included in the student model from parameters of the elements included in the target model or the intermediate model corresponding to the elements included in the student model.

4. The information processing device according to claim 3, wherein
the intermediate model is a neural network model including a plurality of layers each including a plurality of elements, and
for each of intermediate model layers representing the layers included in the intermediate model, the selection unit selects a plurality of element groups each including one or more elements included in the intermediate model layer, and selects, as the initial value, a parameter of the element included in the target model or the intermediate model corresponding to the element included in the element group, among the element groups, that has an evaluation value larger than evaluation values of the other element groups.

5. The information processing device according to claim 4, wherein the evaluation value is a value representing accuracy of an inference using the student model in which the parameter of the element included in the target model or the intermediate model corresponding to the element included in the element group is set as the initial value.

6. The information processing device according to claim 4, wherein when an inference using the student model in which the parameter of the element included in the target model or the intermediate model corresponding to the element included in the element group is set as the initial value is performed on a plurality of pieces of data, the evaluation value is a value that becomes larger as a difference is smaller between a statistic of an output of a corresponding layer included in the student model and a statistic of an output of the intermediate model layer.

7. The information processing device according to claim 4, wherein when a backward process using the student model in which the parameter of the element included in the target model or the intermediate model corresponding to the element included in the element group is set as the initial value is performed on a plurality of pieces of data, the evaluation value is a value that becomes larger as a difference is smaller between a statistic of a gradient calculated for a corresponding layer included in the student model and a statistic of a gradient calculated for the intermediate model layer.

8. The information processing device according to claim 1, wherein
the target model, the intermediate model, and the student model are neural network models including a plurality of layers, and
the change unit includes:
a pruning unit that generates the intermediate model by pruning the target model, and
a generation unit that generates the student model by increasing or decreasing a size of each of the layers included in the intermediate model according to a designated ratio.

9. The information processing device according to claim 1, wherein the target model learning unit pre-learns the target model using a first dataset for pre-learning and learns the pre-learned target model using a second dataset that is different from the first dataset.

10. An information processing device comprising:
one or more hardware processors configured to function as:
a target model learning unit that learns a target model to be subjected to size reduction;
a change unit that changes the target model into a student model with a size smaller than a size of the target model;
a selection unit that selects an initial value of a parameter of the student model from parameters of the target model; and
a student model learning unit that learns the student model using the selected initial value.

11. An information processing method executed in an information processing device, the information processing method comprising:
learning a target model to be subjected to size reduction;
changing the target model into a student model with a size smaller than a size of the target model;
selecting, as a teacher model, one of a plurality of models including the target model and one or more intermediate models with a size smaller than the size of the target model in accordance with a comparison result between the size of the target model and the size of the student model; and
learning the student model by distillation using the selected teacher model.

12. A computer program product having a non-transitory computer readable medium including programmed instructions, wherein the instructions, when executed by a computer, cause the computer to perform:
learning a target model to be subjected to size reduction;
changing the target model into a student model with a size smaller than a size of the target model;
selecting, as a teacher model, one of a plurality of models including the target model and one or more intermediate models with a size smaller than the size of the target model in accordance with a comparison result between the size of the target model and the size of the student model; and
learning the student model by distillation using the selected teacher model.
